(19) United States
(12) Patent Application Publication
(10) Pub. No.: US 2009/0044280 A1
(43) Pub. Date: Feb. 12, 2009

(54) PROXY SERVER, METHOD FOR REALIZING PROXY, AND SECURE COMMUNICATION SYSTEM AND METHOD THEREOF

(75) Inventors: Xuyong WU, Shenzhen (CN); Zhong PAN, Shenzhen (CN); Quanbo ZHAO, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/200,761

(22) Filed: Aug. 28, 2008

Related U.S. Application Data
(63) Continuation of application No. PCT/CN2007/000442, filed on Feb. 8, 2007.

(30) Foreign Application Priority Data
Feb. 28, 2006 (CN) 200610058052.X
Feb. 28, 2006 (CN) 200610067530.3

(51) Int. Cl. H04L 9/00; G06F 15/177

(52) U.S. Cl. 726/26; 709/221

(57) ABSTRACT

A proxy server having proxy server address information is provided to serve as an agent for at least one base station to perform secure communication. A method for realizing proxy and secure communication system are also provided to prevent the change of network address allocation from interfering main services of a base station. In addition, a secure communication method between license-exempt devices is provided to ensure the license-exempt devices not to be attacked and to remain at normal work. In the present invention, the network address of a base station is only restricted in a trusted range instead of being broadcasted in a public network, thus reducing the probability of attack to the base station in a wired network.

### CROSS-REFERENCE TO RELATED APPLICATION

This application is a continuation of International Patent Application No. PCT/CN2007/000442, filed Feb. 8, 2007, which claims priority to Chinese Patent Application Nos. 200610058052.X and 200610067530.3, both filed Feb. 28, 2006, each of which is hereby incorporated by reference in its entirety.

### FIELD OF THE INVENTION

The present invention relates to the communication security technology, and more particularly, to a proxy server, a method for realizing proxy, a secure communication system with the proxy server, and a secure communication method between LE devices.

### BACKGROUND

In recent years, with increasing progress in the communication technology, the communication industry develops rapidly, and the spectrum resources become very precious. Thus, to make a full use of the limited spectrum resources, a license-exempt band (LE band) is particularly designated by International Telecommunications Union. On the premise of not affecting normal work of other devices, LE devices may occupy the band willfully.

Working at the LE band, the LE devices need to get accustomed to the environment, i.e. to detect and avoid interferences or to negotiate with interference sources. Therefore, the LE devices should negotiate with other LE devices on how to share the band, and therefore signaling communication between the LE devices is involved. As two LE devices do not know the address of each other in advance, one has to broadcast its own address, and the other may establish the communication, as desired.

As the two devices in need of resource negotiation have conflicts on resources, their coverage areas overlap. Through terminals in the common coverage area, the two LE devices may broadcast addresses in a wireless manner. After acquiring the address of each other, the two devices switch to a wired manner to perform the subsequent negotiation.

Here, the address generally refers to an IP address. In fact, the two devices in need of resource negotiation usually belong to two different operators or two networks without any mutual trust, and it is quite risky to broadcast over air interfaces the service IP address of a base station (BS). If any malicious device captures the IP address of the LE BS, the device may pretend to need to negotiate resource, or may attack the LE BS to crash the BS.

Further, in some areas, the use of a certain band is under non-exclusive license authorization. In other words, when some device is granted with the license of the band, other devices may also get the right to use this band without informing the authorized device.

In another circumstance, though having obtained the exclusivity of a band within an area, a certain enterprise or operator does not have the ability to or unwilling to set the stations in the manner of planning first and then site layout, instead, wishes the devices to automatically negotiate resource allocation flexibly according to the actual occupation of the air interface resources.

For ease of illustration, the devices/BSs in the above three circumstances are generally referred to as LE devices/BSs or coexistent BSs.

In the network, none of the parameters such as location, occupied resources, and transmit power of each LE device are planned or configured in advance, but the device gets accustomed to the environment, and selects resources and negotiates allocation with other LE devices in a permitted range.

In a LE network, resource negotiation is usually performed between the devices to ensure each device to work normally or optimally. A common case where two LE BSs need to communicate is that, an IBS cannot scan any idle band after being activated, so the IBS has to negotiate with an adjacent OBS on spectrum sharing. As no reliable wireless manner can be adopted for exchanging negotiation information between the BSs in need of negotiation, the communication negotiation between the IBS and the OBS is mainly implemented in a wired manner. In this case, the IBS or OBS must know the wired contact information of each other. Here, initializing base station is abbreviated to IBS, representing a newly activated BS, and operating base station is abbreviated to OBS, representing a BS at normal work.

As the parameters like spectrum, location, transmit power, and coverage of each LE device are not planned in advance, the activation and exit of the LE device are highly random. Therefore, the OBS at normal work may not know which BSs around will be activated, and the newly activated IBS may not know which adjacent OBSs already exist. By broadcasting over the air interfaces, the IBS may send its own contact information within the range of interference, so a terminal which has received information may report the information to an OBS which the terminal belongs to, and accordingly, the OBS may initiate subsequent communication with the IBS.

In view of the above, the LE devices need to get its own address information public in a way to acquire that of the other. There are many ways to get public, for example, to transit the information to the BS of the counterpart through the terminal capable of broadcasting the contact information to the counterpart in the common coverage area when the devices have an overlap coverage, or to query the counterpart and the contact information thereof according to location or other information through a well-known area server. After obtaining the contact information of the counterpart, the devices further switch to a wired manner to perform subsequent negotiation.

The LE BSs in need of coexistent negotiation broadcast and obtain network addresses of related LE BSs directly through air interfaces or public servers, and begin contact through the public network addresses. Here, the address generally refers to the network address, i.e. IP address. In fact, the devices in need of resource negotiation usually belong to different operators or networks without any trust relationship between each other, and it is quite risky to directly broadcast the service IP address of the BS. If any malicious attacker captures the service IP address of the wireless BS, the attacker may directly attack the network port of the BS.

FIG. 1 is a schematic view of obtaining network addresses and communicating between LE BSs. Assuming that the IBS broadcasts its IP address through air interfaces, a terminal under interference transmits the received IP address to the OBS which the terminal belongs to, and the OBS directly initiates from a wired network a contact request of the IBS corresponding to the IP address based on the reported IP address. After the IBS receives the request and feeds back a message to the OBS, a subsequent communication mechanism is established. As described above, the IBS broadcasts its address over the air interfaces, that is, to disclose its network address; and therefore the IBS may be easily attacked, and the communication security between the LE BSs may be reduced.

### SUMMARY

Embodiments of the present invention are mainly directed to a proxy server configured to serve as an agent for transmitting/receiving a coexistent signaling between base stations (BSs).

Embodiments of the present invention are also directed to a method for realizing proxy by the proxy server to prevent the change of network address allocation from interfering main services of a BS.

Embodiments of the present invention are further directed to a secure communication system with the proxy server to prevent the change of network address allocation from interfering main services of a BS.

Embodiments of the present invention are still further directed to a secure communication method between LE devices to ensure the LE devices not to be attacked and to remain at normal work.

In order to achieve the above objectives, technical solutions of the embodiments of the present invention are realized as fellows:

A proxy server is provided having proxy server address information, which includes a proxy database and a processing unit.

The proxy database is adapted to store BS address information of at least one BS and BS identification (BS ID) information corresponding to the BS address information.

The processing unit is adapted to replace a BS source address information in a first message from the at least one source BS with a proxy server address information of the proxy server, and send a second message carrying the proxy server address information to a target address.

The processing unit is further adapted to parse the first message, and when the first message carries no source BS ID information, add the BS ID information corresponding to the source BS address information into the first message, so as to generate the second message carrying the BS ID information and the proxy server address information.

A method for realizing proxy by the proxy server is provided, which includes the following steps.

In Step A, the BS address information of the at least one BS and the BS ID information corresponding to the BS address information are stored in advance.

In Step B, the BS source address information in the first message from the at least one BS is replaced by the proxy server address information of the proxy server.

In Step C, the second message carrying the proxy server address information is sent to the target address.

A secure communication system is provided, which includes at least one BS, and the proxy server adapted to serve as an agent for the at least one BS to perform secure communication.

A communication method for achieving secure communication between at least a first BS and a second BS is provided. In addition, the first BS has at least one first proxy server. The method includes the following steps.

In Step A, the first BS sends a first message to the second BS. The first message includes a first network address of the first proxy server and a first BS ID of the first BS.

In Step B, the second BS sends a contact request message to the first BS according to the first BS ID carried in the first message, and the first BS sends a response message to the second BS to achieve secure communication with the second BS.

Seen from the above technical solutions, in the embodiments of the present invention, the network address of a BS is only applicable in a trusted range instead of being disclosed in air interfaces and the whole network, which greatly reduces the probability of attack to the BS in a wired network. Through the above technical solutions, the embodiments of the present invention may achieve the following technical effects.

1. As the network interface of the BS has to bear plenty of data services and related controls, the change of the IP address may cause a lot of negative impacts. However, the coexistence proxy connected to each BS only serves as an agent for transmitting/receiving a coexistent signaling, so the change of the network address allocation does not affect the main services of the BS, and multiple proxies may be back up for each other. Meanwhile, as the amount of information to be processed by the coexistence proxy is small, its required bandwidth is not high, and thus the probability of crash by an attack is small. Therefore, the coexistence proxy is advantageous in having a simple function and low cost, and multiple proxy backups can be adopted to enhance the reliability.

2. In the present invention, the network address of a BS is only restricted in a trusted range instead of being broadcasted in a public network, thus reducing the probability of attack to the BS in a wired network.

3. When a single proxy crashes by attack, its communication with the LE devices is remained by altering the proxy IP address or activating a backup proxy, so as to avoid interfering the service network of the BS.

### BRIEF DESCRIPTION OF THE DRAWINGS

FIG. 1 is a flow chart illustrating message exchange of obtaining network addresses and communicating between LE BSs;

FIG. 2 is a logic block diagram of a proxy server according to the present invention;

FIG. 3 is a flow chart illustrating a method for performing secure communication through a server acting as a proxy for at least one BS according to the present invention;

FIG. 4 is a flow chart of the work process of a proxy server in sponsor side according to the present invention;

FIG. 5 is a flow chart of the work process of a proxy server in responser side according to the present invention;

FIG. 6 is a schematic view illustrating connection modes between proxy servers and BSs according to the present invention;

FIGS. 7a-7c are schematic views illustrating corresponding relationships between proxy servers and BSs according to the present invention;

FIGS. 8a-8f are network topological graphs and logic block diagrams illustrating connections between proxy servers and BSs according to the present invention;

FIG. 9 is a flow chart illustrating a communication method according to an embodiment of the present invention;

FIG. 10 is a flow chart illustrating message exchange corresponding to the communication method in FIG. 9;

FIG. 11 is a flow chart illustrating a communication method according to another embodiment of the present invention;

FIG. 12 is a flow chart illustrating a communication method according to yet another embodiment of the present invention;

FIG. 13 is a flow chart illustrating message exchange corresponding to the communication method according to another embodiment of the present invention;

FIG. 14 is a flow chart illustrating message exchange corresponding to the communication method according to yet another embodiment of the present invention;

FIG. 15 is a flow chart illustrating message exchange corresponding to the communication method according to still another embodiment of the present invention;

FIG. 16 is a schematic flow chart illustrating processes of an IBS in the above communication method; and

FIG. 17 is a schematic flow chart illustrating processes of an OBS in the above communication method.

### DETAILED DESCRIPTION

In order to make the objectives, technical solutions, and advantages of the present invention comprehensible, embodiments accompanied with drawings are described in detail below.

In the present invention, an IBS broadcasts the address of its coexistence proxy and a BS ID of its own instead of the network address adopted by services of the IBS itself. Here, the BS ID may be any identifier that uniquely identifies the BS, for example, a fixedly allocated BS identifier, or a MAC address of the BS, or even a port number of a proxy.

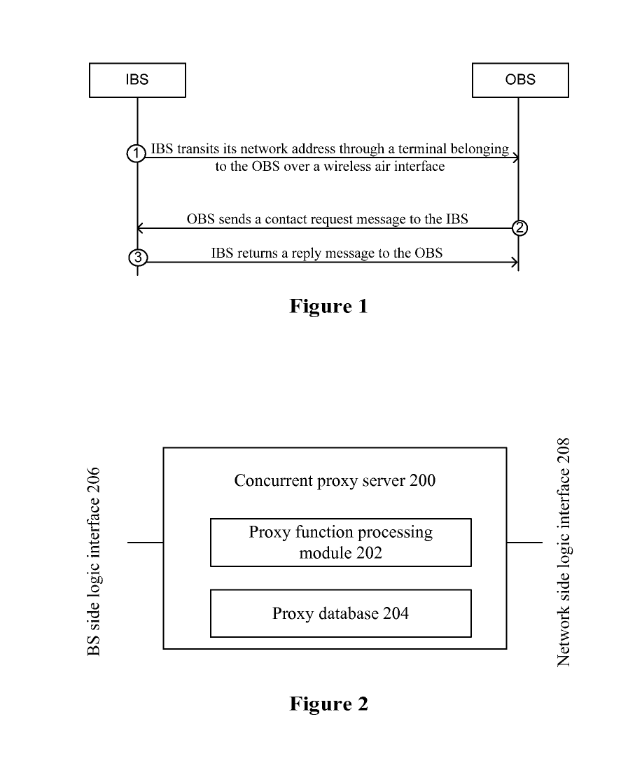

FIG. 2 is a logic block diagram of a coexistence proxy server 200 according to the present invention. As shown in FIG. 2, the coexistence proxy server may also be called as a coexistence proxy. The coexistence proxy server 200 serving as an agent for transmitting/receiving a coexistent signaling between BSs may be a functional module in a device or may be an independent device.

The coexistence proxy server 200 includes a processing unit, i.e. a proxy function processing module 202, a proxy database 204, a BS side logic interface 206, and a network side logic interface 208.

In addition, the following information is stored in the proxy database 204: IDs of all the BSs under its proxy, network addresses of all the BSs under its proxy, and mapping relationships between the IDs and the network addresses of all the BSs under its proxy.

In an exemplary embodiment, the following information is stored in the proxy database 204: illegal proxy addresses lists; illegal message records or statistics of each proxy; and sending records or statistics of an illegal source BS address.

The proxy function processing module 202 is provided with the following basic functions:

1. Authorized to Send Coexistent Message

1) receiving on the BS side logic interface 206: receive a message to be sent through a known BS network address, and the received message must carry a target BS ID and a target proxy network address;

2) source network address replacement and source BS ID appending to the message to be sent: obtain a source BS ID from a mapping table according to the received source network address, add the BS ID into a message to be sent, and remove the source network address from the message to be sent, so as to replace the source network address of the BS with this proxy network address;

3) the coexistence proxy detection: detect whether the target proxy network address is identical to this proxy, and if the target proxy network address is identical to this proxy, directly perform a coexistent message receiving proxy function on the message sent by this proxy (this function is only provided under the proxy of multiple BSs); and

4) sending on the network side logic interface 208: send a message carrying the target BS ID, the network address of this proxy, and the source BS ID according to the target proxy address.

2. Authorized to Receiving Coexistent Message

1) receiving on the network side logic interface 208: receive a coexistent message carrying a source BS ID from a source proxy, and obtain a target BS ID;

2) query and replacement of a target address in a received message: obtain a network address corresponding to the BS from a mapping table according to the target BS ID in the received coexistent message, and remove the target proxy network address information in the message; and

3) sending on BS side logic interface 206: send the received message, the source proxy address, and the source BS ID according to the acquired target BS network address.

Further, the proxy function processing module 202 also may realize the following extended functions:

1) determining and reporting/feeding back the working state of a proxy, so as to determine whether the proxy server 200 can work normally or suffers an illegal attack;

2) determining and feeding back an abnormal message, so as to determine an illegal BS and an illegal proxy server;

3) activating a backup notification;

4) reporting an illegal attack message;

5) shading an illegal proxy address;

6) dynamically updating a mapping table between IDs and network addresses;

7) updating an illegal proxy address; and

8) negotiating between the proxies.

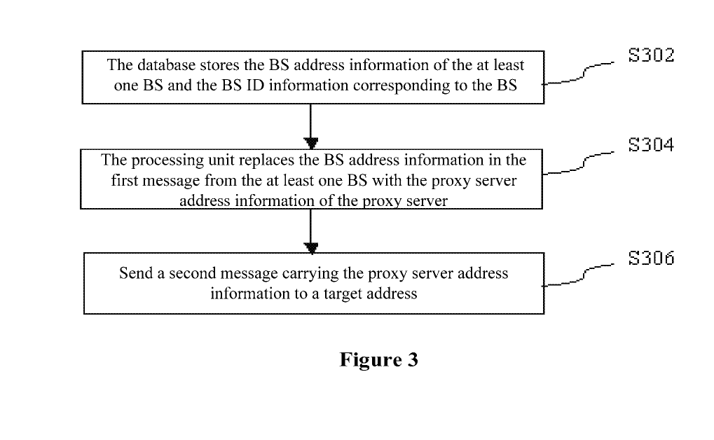

FIG. 3 is a flow chart illustrating a method of secure communication through a server acting as a proxy for at least one BS according to an embodiment of the present invention.

First, a database is built for storing BS address information of the at least one BS and BS ID information corresponding to the BS address information. This step is a preparatory step, and is not shown in FIG. 3.

Then, the following steps are performed.

In Step S302, the processing unit 202 adds the BS ID information corresponding to the BS address information of the at least one BS into a first message from the at least one BS.

In Step S304, the BS address information of the at least one BS is replaced by the proxy server address information.

In Step S306, a second message carrying the BS ID information and the proxy server address information is sent to a target address.

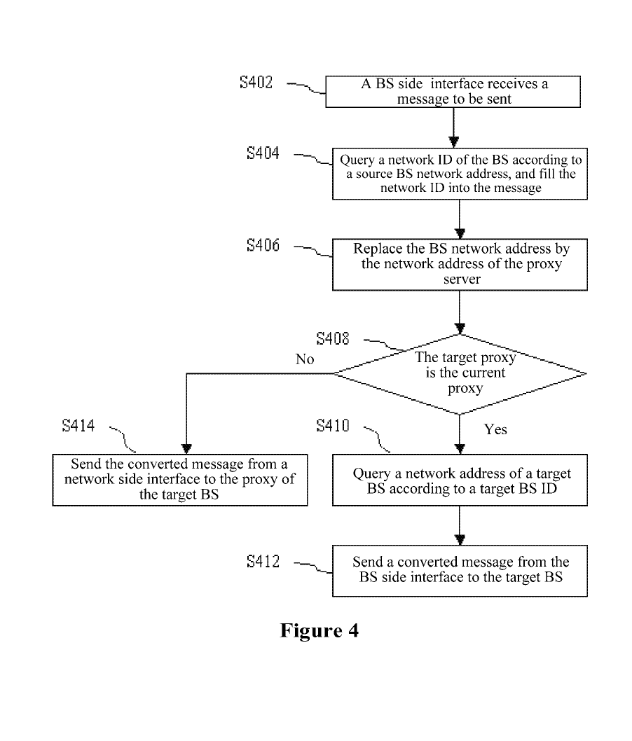

FIG. 4 is a flow chart of a proxy sending process of a proxy server according to the present invention.

In Step S402, a BS side logic interface receives a message to be sent.

In Step S404, a network ID of the BS is queried according to a source BS network address carried in the message to be sent, and then the network ID is filled into the message.

In Step S406, the source BS network address is replaced by the network address of the proxy server.

In Step S408, it is determined whether the target proxy is the current proxy, and if the target proxy is the current proxy, Step S410 is performed; if the target proxy is not the current proxy, Step S414 is performed.

In Step S410, a network address of a target BS is queried according to a target BS ID.

In Step S412, a transformed message is sent from the BS side logic interface to the target BS, and the process ends.

In Step S414, the transformed message is sent from a network side logic interface to the proxy of the target BS.

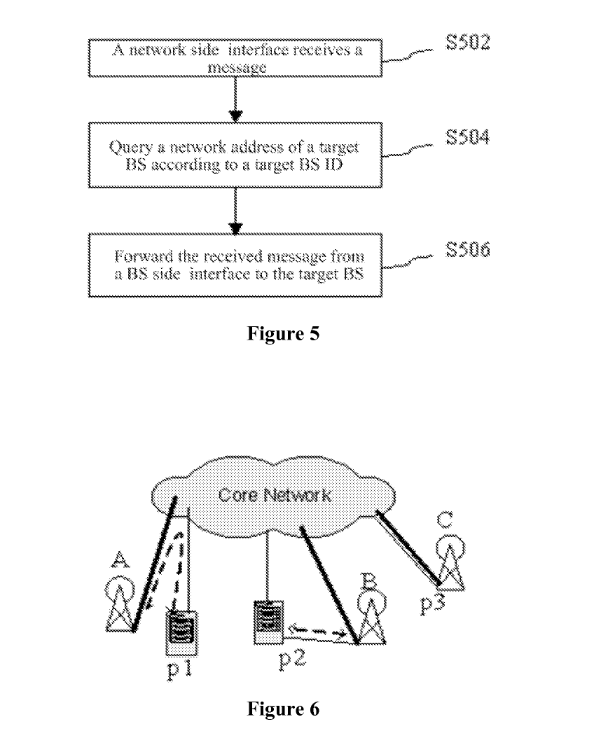

FIG. 5 is a flow chart of authorized receiving process of a proxy server according to the present invention.

In Step S502, a message is received through a network side logic interface.

In Step S504, a network address of a target BS is queried according to a target BS ID carried in the received message.

In Step S506, the received message is forwarded from a BS side logic interface to the target BS.

FIG. 6 is a schematic view illustrating connection modes between proxy servers and BSs according to the present invention. As shown in FIG. 6, BSs A, B, and C and proxy servers p1, p2 and p3, corresponding to BSs A, B, C respectively, form a secure communication system. To explain more explicitly, FIG. 6 shows three connection modes between the proxy servers and the BSs, and it should be noted that the modes are given for illustration only instead of limiting the present invention. Moreover, the connection modes between the proxy servers and devices of the BSs are neither limited to the above three interface types.

In FIG. 6, the heavy lines represent service channels, and the fine lines represent coexistent message channels.

1) The BS A is connected to the proxy p1 through another device such as a core network device. Thus, a coexistent message network interface and a service channel interface of the BS A may be a public physical interface or two independent interfaces. Besides, the logic interfaces of the proxy p1 to the BS and to the network may be a public physical interface or independent physical interfaces.

2) The BS B is directly connected to the proxy p2. Thereby, a coexistent message network interface and a service channel interface of the BS B are independent from each other, and logic interfaces of the proxy p2 to the BS and to the network are also independent from each other.

3) A functional module of the coexistence proxy p3 is integrated inside the BS C device. Thereby, the BS C provides two physical interfaces outward corresponding to two network addresses for bearing the service channel and coexistent message channel respectively.

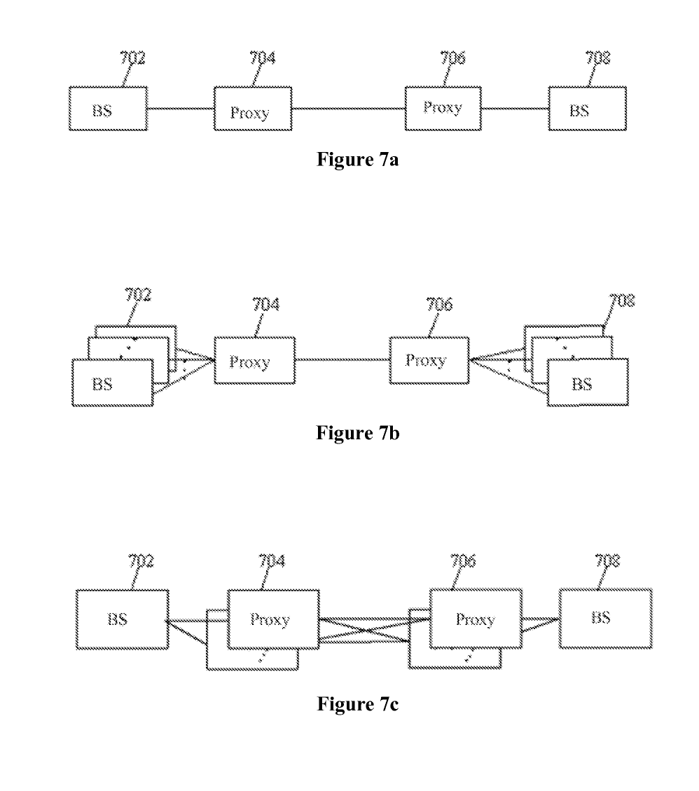

FIGS. 7a-7c are schematic views illustrating corresponding relationships between proxy servers and BSs according to the present invention.

FIG. 7a shows a circumstance that each coexistent BS owns one coexistence proxy server. Here, a BS 702 is corresponding to a proxy 704, and a proxy 706 is corresponding to a BS 708. A secure communication between the BS 702 and BS 708 is established through the proxy 704 and proxy 706. Further, the proxy 704 and proxy 706 may be the same proxy server.

A coexistence proxy may be uniquely corresponding to one coexistent BS. So that, only one entry of BS information, including the BS ID and the BS network address, of the corresponding BS exists in the database. Thus, the BS may integrate the coexistence proxy functional module inside the BS device, and additionally configures coexistent network interfaces independent from the service interfaces. Moreover, the coexistent channels are isolated from the main services channels. In this circumstance, the BS side logic interface of the proxy server is connected to the BS inside the device instead of through a physical interface outside the device. Of course, an independent coexistence proxy device may also be set outside the BS device to serve as an agent for only one BS.

FIG. 7b shows a circumstance that multiple coexistent BSs share one coexistence proxy server.

In FIG. 7b, multiple BSs 702 share one proxy 704, and secure communications between the multiple BSs 702 are established through the proxy 704. Multiple BSs 706 share one proxy 708, and secure communications between the multiple BSs 704 are established through the proxy 708. Further, secure connections between the BSs 702 and the BSs 706 are established through the proxies 704 and 708.

So that, entries of BS network address, BS ID, and mapping relationship in the proxy database have multiple items, and the coexistence proxy is usually independent of the BSs.

FIG. 7c shows a circumstance that one coexistent BS owns multiple coexistence proxy servers.

Under this circumstance, one BS 702 has multiple proxies 704, and these proxy servers may perform mutual backup or load sharing. One BS 706 has multiple proxies 708, and these proxy servers may also perform mutual backup or load sharing.

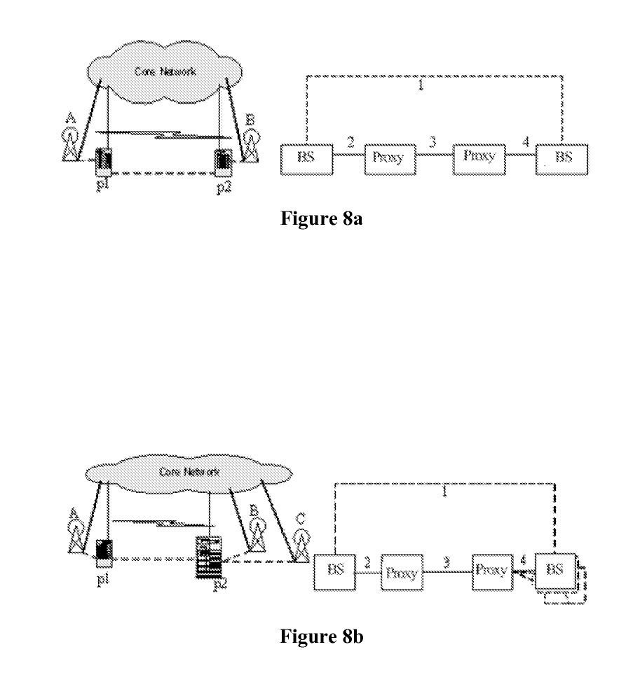

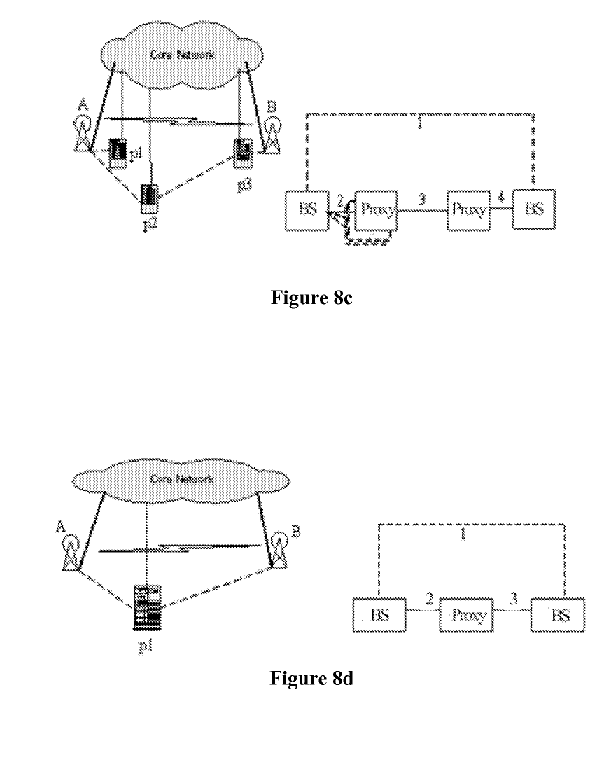

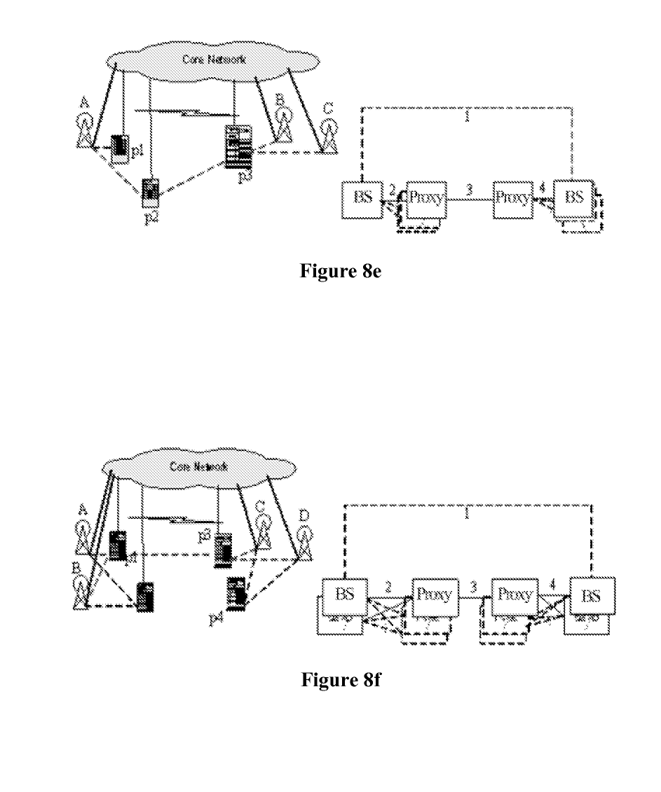

FIGS. 8a-8f are examples showing applications of the proxy server according to the present invention. Each figure has a topological graph on the left side and a logic block diagram on the right side.

FIG. 8a shows a circumstance that each coexistent BS owns one coexistence proxy. In FIG. 8a, a coexistence proxy p1 serves as an agent for transmitting/receiving a coexistent message for a BS A, and a coexistence proxy p2 serves as an agent for transmitting/receiving a coexistent message for a BS B. The coexistent message transmitted and received by the BS A has to be forwarded by the coexistence proxy p1. The coexistent BSs and proxies other than the BS A and the coexistence proxy p1 do not know the network address of the BS A. The relationship between the BS B and the coexistence proxy p2 is the same as that between the BS A and the coexistence proxy p1. Coexistent message exchanges between the BSs A and B require the coexistent proxies p1 and p2 to forward the messages.

FIG. 8b shows a circumstance that one coexistence proxy deals with multiple BSs. In FIG. 8b, a coexistence proxy p2 serves as an agent for two coexistent BSs B and C. Thereby, coexistent message exchange between the BSs B and C is implemented through the coexistence proxy p2, and the coexistence proxy p1 serves as an agent for the BS A. Coexistent message exchanges between the BSs A and B and that between the BSs A and C require the coexistent proxies p1 and p2 to forward the messages.

FIG. 8c shows a circumstance that one BS owns multiple proxies. When one BS owns multiple proxies, the network address of one coexistence proxy is usually broadcasted and another coexistence proxy serves as a backup. Once the coexistence proxy in use fails, the communication is switched to another proxy through broadcast to resume the subsequent coexistent message exchange. In addition, multiple coexistent proxies may also be broadcasted at the same time for mutual load sharing and online backup. In FIG. 8c, coexistent proxies p1 and p2 both serve as an agent for a BS A, and a coexistence proxy p3 serves as an agent for a BS B. Coexistence proxy p2 is selected to forward the messages exchanged between the BSs A and B.

FIG. 8d shows a circumstance of proxy serving multiple BSs on transmitting/receiving coexistent messages. In this circumstance, though multiple BSs share the same proxy, they do not know each other's network address. The coexistence proxy has to serve as an intermediate for coexistent negotiation and to forward coexistent messages between two coexistent BSs, so that the coexistent BSs may not directly acquire the network address of each other in a wired network. As shown in FIG. 8d, BSs A and B share the same coexistence proxy p1.

FIG. 8e shows a circumstance where one BS owns multiple proxies and multiple BSs share one proxy. FIG. 8f shows a circumstance where one proxy serves multiple BSs and each BS is provided with multiple proxies. When one BS owns multiple proxies, the network address of one coexistence proxy is broadcasted and another coexistence proxy serves as a backup. Therefore, once the coexistence proxy in use fails, the communication is switched to another proxy through broadcast to resume the subsequent coexistent message exchange. Meanwhile, multiple coexistent proxies may also be broadcasted for mutual load sharing and online backup. In FIG. 8e, coexistent proxies p1 and p2 both serve as an agent for a BS A, and a coexistence proxy p3 serves as an agent for a BS B. Coexistence proxy p2 is selected to forward the messages exchanged between the BSs A and B.

In view of the above, as the network interface of the BS has to bear data services and related controls, the change of the IP address may cause a lot of negative impacts. However, the coexistence proxy connected to each BS only serves as an agent for transmitting/receiving coexistent signaling, so the change of the network address allocation does not affect the main services of the BS, and multiple proxies may be back up for each other. Meanwhile, as the amount of information to be processed by the coexistence proxy is reduced, its required bandwidth is not high, and thus it has a small probability of crash by attack. Therefore, the coexistence proxy is advantageous in having a simple function and low cost, and multiple proxy backups can be adopted to enhance the reliability.

When the proxy server receives the coexistent message sent by the BS under its proxy, the proxy server removes the source network address of the BS in the message and adds in its own network address as the source network address. Meanwhile, the proxy server fills in or ensures the BS ID in the message, and sends the transformed message to a target address. When the proxy server receives the coexistent message from a source other than the BS under its proxy, the proxy identifies the coexistent message to be sent to the BS under its proxy according to the BS ID, and then forwards the message to the corresponding BS under its proxy. The coexistence proxy server provided by the present invention is, but not limited to, a functional module integrated in a coexistent BS or an independent coexistence proxy device.

According to the present invention, the network address of a BS is only restricted in a trusted range instead of being broadcasted in a public network, and thus the probability of attack to the BS in a wired network is reduced.

When a single proxy crashes by attack, its communication with the LE devices is remained by altering the proxy IP address or activating a backup proxy, so as to avoid interfering the service network of the BS.

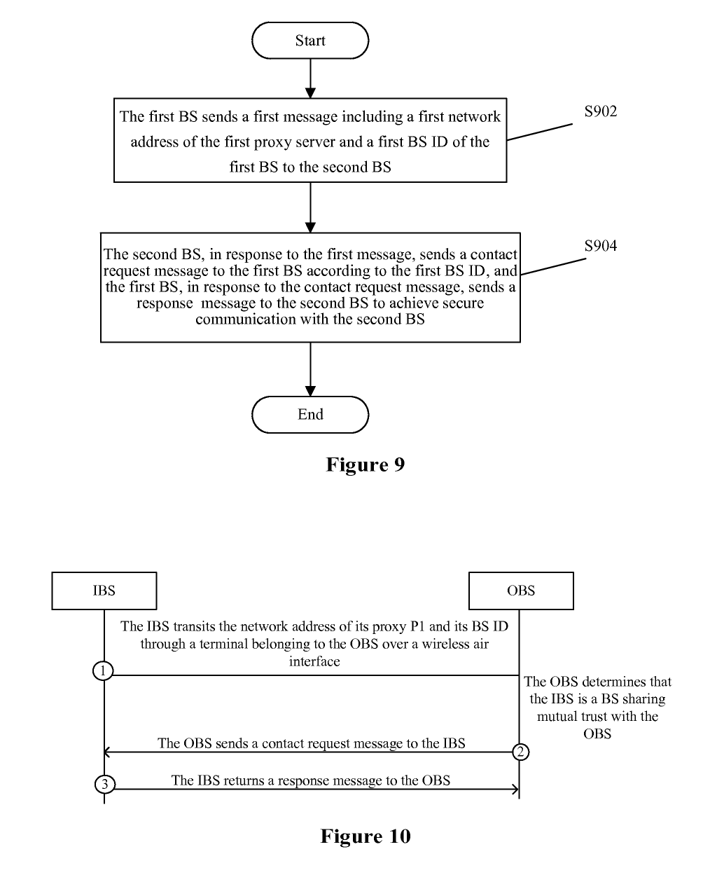

FIG. 9 is a flow chart illustrating a communication method according to an embodiment of the present invention. The method is adopted to achieve secure communication between at least a first BS and a second BS. In addition, the first BS includes at least one first proxy server. As shown in FIG. 9, the communication method includes the following steps.

In Step S902, the first BS sends a first message to the second BS. The first message includes a first network address of the first proxy server and a first BS ID of the first BS.

In Step S904, the second BS, in response to the first message, sends a contact request message to the first BS according to the first BS ID carried in the first message, and then the first BS, in response to the contact request message, sends a response message to the second BS, so as to achieve secure communication with the second BS.

FIG. 10 is a flow chart illustrating processes of message exchange corresponding to the communication method in FIG. 9. As shown in FIG. 10, the IBS sends over a wireless air interface a network address of a proxy server (also referred to as a proxy) P1 and a BS ID of the IBS itself to the OBS. On determining that the IBS is a BS sharing mutual trust with the OBS, the OBS sends a request message to the IBS, and the IBS returns a response message to the OBS in response to the request message.

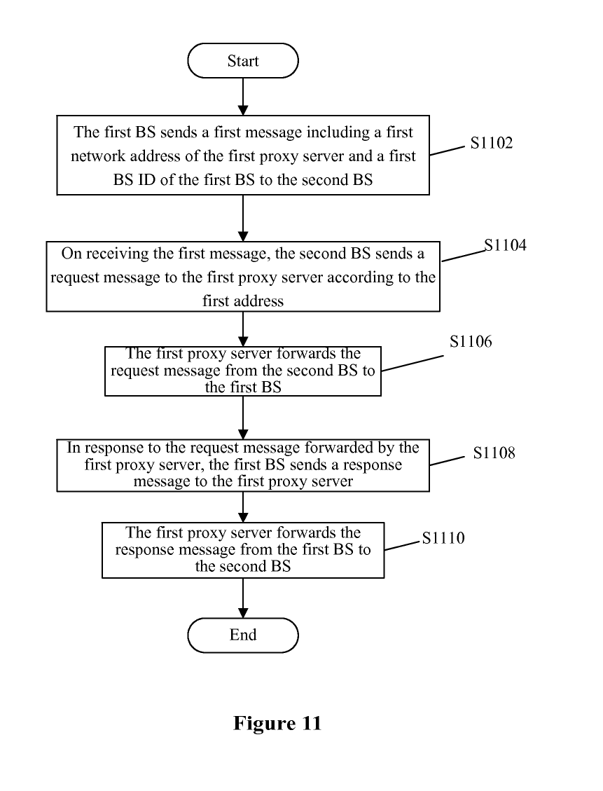

FIG. 11 is a flow chart illustrating a communication method according to another embodiment of the present invention. The communication method includes the following steps.

In Step S1102, the first BS sends a first message to the second BS. The first message includes a first network address of the first proxy server and a first BS ID of the first BS.

In Step S1104, on receiving the first message, the second BS sends a request message to the first proxy server according to the first network address carried in the first message.

In Step S1106, the first proxy server forwards the request message from the second BS to the first BS.

In Step S1108, in response to the request message forwarded by the first proxy server, the first BS sends a response message to the first proxy server.

In Step S1110, the first proxy server forwards the response message sent from the first BS to the second BS.

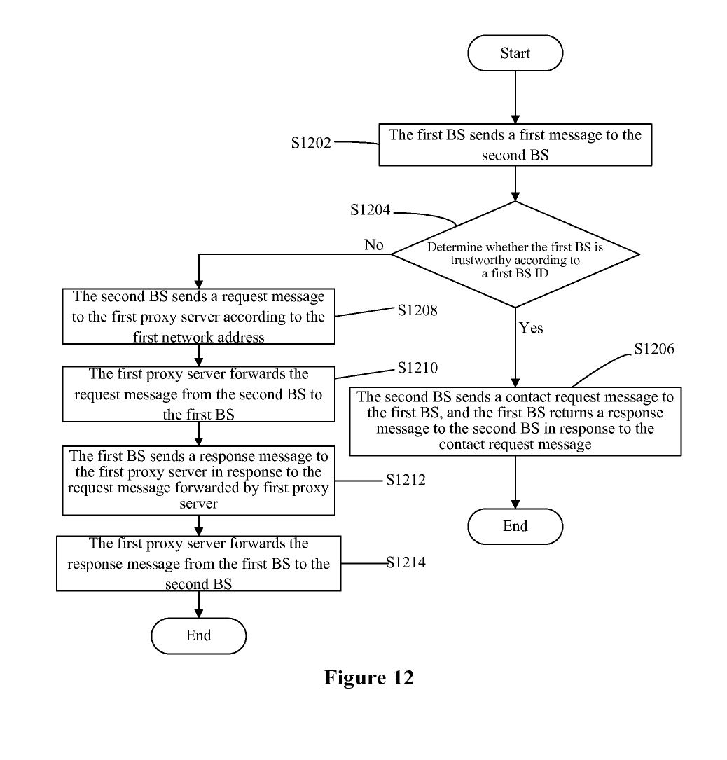

FIG. 12 is a flow chart illustrating a communication method according to yet another embodiment of the present invention. The method is adopted to achieve secure communication between at least a first BS and a second BS. In addition, the first BS includes at least one first proxy server, and the second BS includes at least one second proxy server. As shown in FIG. 12, the communication method includes the following steps.

In Step S1202, the first BS sends a first message to the second BS. The first message includes a first network address of the first proxy server and a first BS ID of the first BS.

In Step S1204, in response to the first message, the second BS determines whether the first BS is trustworthy according to the first BS ID carried in the first message upon a first condition, and if the first BS is trustworthy, Step S1206 is performed; the first BS is not trustworthy, Step S1208 is performed.

The first condition includes at least one of the following factors: the first BS and the second BS knowing each other's network address, they knowing that they belong to the same operator, they knowing that they are sharing one proxy server, they knowing each other's encrypted public key and that the signature is right, and they knowing the rules of manual configuration. The BS ID may be any identifier that uniquely identifies the first BS, including at least one of a BS identifier, a MAC address of the BS, or a port number of a proxy.

In Step S1206, the second BS sends a contact request message to the first BS, and the first BS, in response to the contact request message, sends a response message to the second BS, so as to achieve secure communication with the second BS, and then the process ends.

In Step S1208, the second BS sends a request message to the first proxy server according to the first network address.

In Step S1210, the first proxy server forwards the request message from the second BS to the first BS.

In Step S1212, the first BS sends a response message to the first proxy server in response to the request message forwarded by first proxy server.

In Step S1214, the first proxy server forwards the response message sent from the first BS to the second BS.

In the above method, the first BS is an IBS, and the second BS is an OBS.

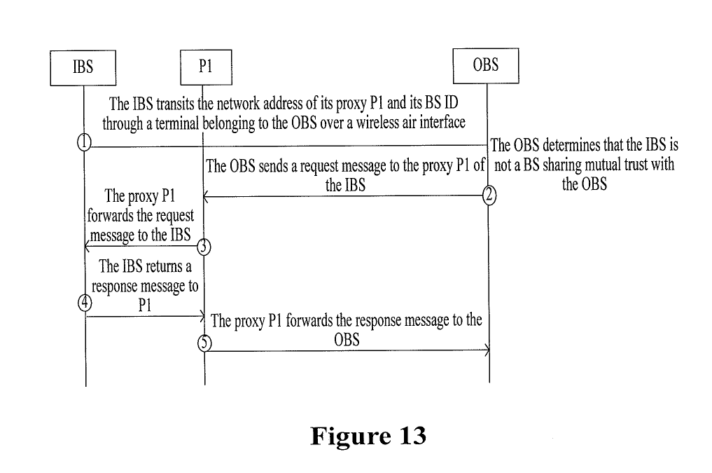

FIG. 13 is a flow chart illustrating processes of message exchange corresponding to the communication method according to another embodiment of the present invention. As shown in FIG. 13, the IBS and the OBS sharing mutual trust can directly exchange messages. The BS in the message received is identified to be a trusted BS by the OBS, and the network address of the IBS can be found in the OBS. Thus, the OBS directly sends a corresponding session request message to the IBS, so that the IBS and the OBS can directly carry out session contact. Different from the flow chart of processes of the message exchange shown in FIG. 3, the IBS is provided with a proxy P1, and sends the network address of the proxy P1 and the BS ID of the IBS itself to the OBS via the air interface. On determining that the IBS is not a BS sharing mutual trust with the OBS, the OBS sends a request message to the proxy P1 of the IBS, and the proxy P1 forwards the request message to the IBS. Then, in response to the request message, the IBS sends a response message to the proxy P1, and the proxy P1 forwards the response message to the OBS.

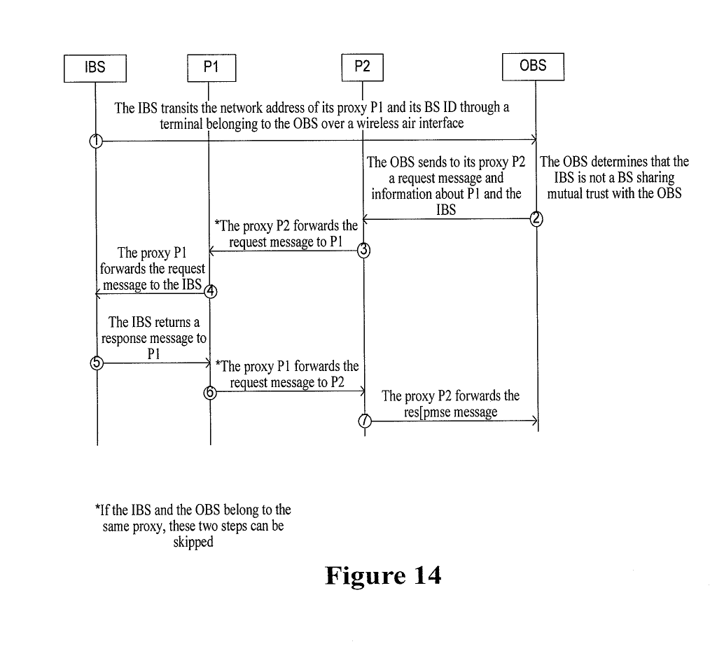

FIG. 14 is a flow chart illustrating processes of message exchange corresponding to the communication method according to still another embodiment of the present invention. As shown in FIG. 14, P1 is a proxy of an IBS, and P2 is a proxy of an OBS.

The IBS broadcasts the address of the coexistence proxy P1 and the BS ID of itself. Here, the BS ID may be any identifier that can uniquely identify the BS, for example, a fixedly allocated BS identifier, or a MAC address of the BS, or even a port number of a proxy.

However, when determining that the IBS is not a BS sharing mutual trust on receiving the information, the OBS initiates the communication with the IBS through the proxy of the OBS. The following options exist. When determining that the IBS is a completely trustworthy BS and when a database contains the network address of its counterpart like the same operator or other unified configurations, the OBS may choose to directly communicate with the IBS or communicate with the proxy of the IBS.

BSs sharing mutual trust are a set of BSs under unified management and recorded with IDs and network addresses of each other in advance. For example, BSs belonging to the same operator share mutual trust. The OBS identifies the BS ID of the IBS to see whether the IBS is trustworthy and also to query the network address of the IBS. The coexistence proxy information is configured before the initialization of the air interface of the IBS, and the coexistence proxy shares mutual trust with the BS. In this embodiment, the proxy keeps the BS network address of the IBS as a secret, and only negotiates with its own network address and the ID of the IBS. In addition, the BS ID is uniquely mapped to the network address of the BS at the proxy.

When the BS identified in the message received by the OBS is not trusted by this OBS or the network address of the IBS cannot be queried at this OBS, the OBS forwards a corresponding session request message with its own BS ID, the ID of the IBS, and the address of the proxy P1 to the proxy P2 of the OBS. The proxy P2 forwards the session to P1 according to the address of the proxy P1, and P1 further forwards the message received from P2 to the IBS according to the ID of the IBS. After the IBS makes a response, the proxy P1 forwards the session to P2, and P2 further forwards the session to the OBS. In this manner, the required session contact is implemented between the IBS and the OBS.

On determining that the IBS is trustworthy, the OBS may query the address of the IBS according to the BS ID. The above communication process can be simplified to the process shown in FIG. 8. In other words, two BSs directly contact without through a proxy.

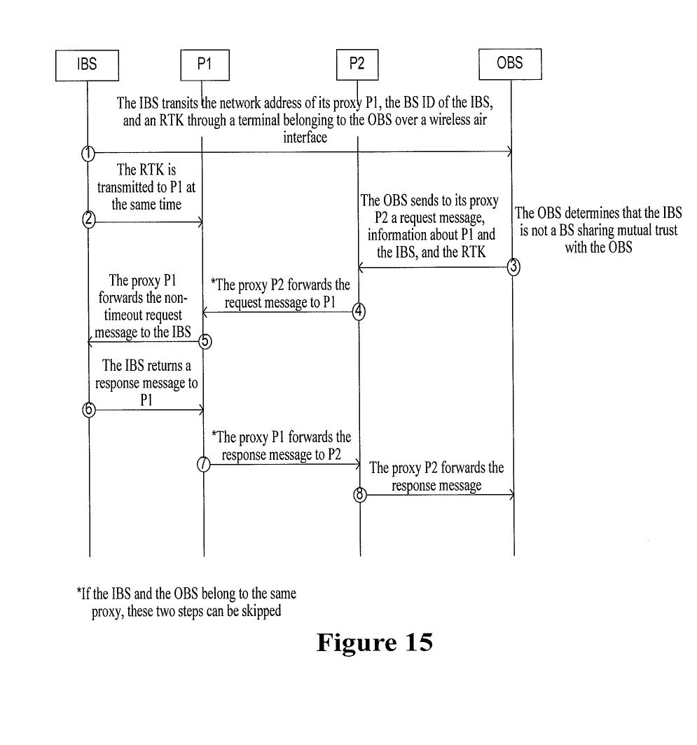

FIG. 15 is a flow chart illustrating processes of message exchange corresponding to the communication method according to yet another embodiment of the present invention. On the basis of the embodiment illustrated in FIG. 7, this embodiment illustrated in FIG. 15 adds a real-time key (RTK) to determine the timeliness of message response, so as to exclude resource negotiation disguised by malicious devices through broadcasting the address of the proxy. Further, if the message broadcast over an air interface is disseminated, the proxy P1 of the IBS may suffer a large number of attacks. In order to enhance the attack-resistance of the proxy, an RTK is added into the wireless broadcast message of the IBS. The RTK is random data generated by the IBS in real time, and each RTK only has a certain validity period. Due to its randomness and validity, the malicious devices have a difficulty to simulate, and therefore whether a response from the OBS is invalid or not can be determined. As shown in FIG. 15, the process generally includes the following steps.

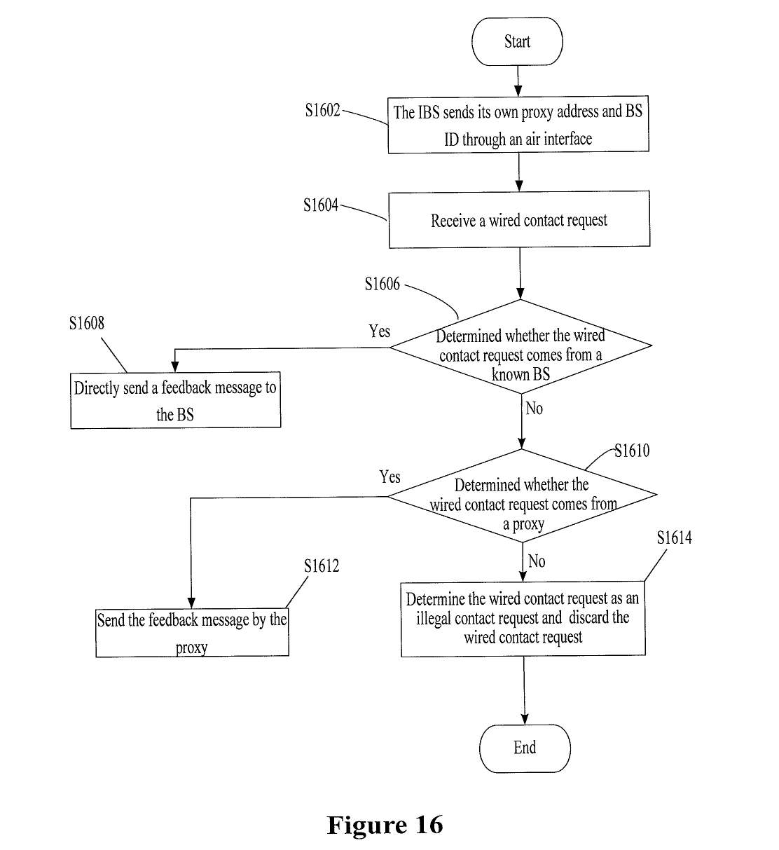

First, during the radio broadcasting of the IBS, the RTK is transferred to the proxy P1 of the IBS to maintain the effectiveness of the RTK. The contact request fed back by the OBS also needs to return the RTK through transparent transmission. If the RTK in the contact request received by the proxy P1 of the IBS is a timeout RTK, i.e. an expired RTK, the request is determined as illegal and should be discarded. Therefore, the initial process of contact between the IBS and the OBS through proxies is shown in FIG. 16. In particular, the proxy P1 of the IBS requires the request message forwarded by P2 to be filtered on a timing basis, and the timeout contact request is discarded. Other steps are similar to the above.

FIG. 16 is a schematic flow chart illustrating processes of an IBS by combining the above embodiments. After broadcasting a message, the IBS waits for a contact request as a response from the OBS in a wired network. The contact request may be received from a known BS or from the local proxy. The IBS needs to transmit the local response to the source of the contact request. Responses from other interfaces or devices are regarded as illegal, and should be discarded. In detail, as shown in FIG. 9, the process includes the following steps.

In Step S1602, the IBS sends its own proxy address and BS ID through an air interface.

In Step S1604, the IBS receives a wired contact request from the OBS.

In Step S1606, the IBS determines whether the wired contact request comes from a known BS, and if the wired contact request comes from a known BS, Step S1608 is performed; if the wired contact request does not come from a known BS, Step S1610 is performed.

In Step S1608, a feedback message is directly sent to the BS, and the process ends.

In Step S1610, it is determined whether the wired contact request comes from a proxy, and if the wired contact request comes from a proxy, Step S1612 is performed; if the wired contact request does not come from a proxy, Step S1614 is performed.

In Step S1612, the feedback message is sent by the proxy, and the process ends.

In Step S1614, the wired contact request is determined as an illegal contact request, and is discarded.

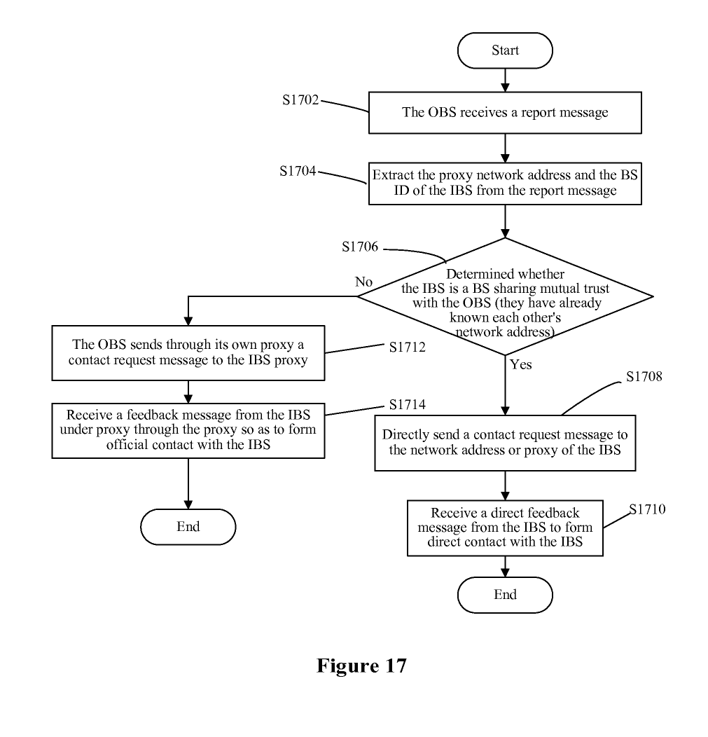

FIG. 17 is a schematic flow chart illustrating processes of an OBS by combining the above embodiments. The OBS processes in different ways depending on the fact whether the BS ID contained in the received message is an ID of a trustworthy BS. When the BS receives through its SS a forwarded and reported message, it is detected whether the BS indicated by the ID contained in the message is trustworthy and recorded with the network address. If the BS indicated by the ID contained in the message is trustworthy and recorded with the network address, the OBS directly communicates with the BS through the network address, or the OBS directly sends a contact request to the IBS through the IBS proxy in the message. If the BS indicated by the ID contained in the message is not trustworthy and recorded with the network address, the OBS may only send a contact request to the IBS to the proxy of the IBS through its own proxy. In detail, the process includes the following steps.

In Step S1702, the OBS receives a report message.

In Step S1704, the OBS obtains the proxy network address and the BS ID of the IBS from the report message.

In Step S1706, the OBS determines whether the IBS is a BS sharing mutual trust with the OBS, and if the IBS is a BS sharing mutual trust with the OBS, Step S1708 is performed; if the IBS is not a BS sharing mutual trust with the OBS, Step S1712 is performed.

In Steps S1712 to S1714, the OBS sends through its own proxy a contact request message to the IBS proxy, and receives feedback message from the proxy of the IBS through the proxy of the OBS, so as to officially contact the IBS. Then, the process ends.

In Steps S1708 to S1710, the OBS directly sends the contact request message to the network address or proxy of the IBS, and receives a direct feedback message from the IBS, so as to directly contact the IBS.

As the BS has to bear services, the IP address of the BS must be relatively fixed. However, the coexistence proxy connected to each BS only serves as an agent for transmitting/receiving a coexistent signaling, so the change of the network address allocation has a small impact, and multiple proxies may back up each other. Meanwhile, as the amount of information to be processed by the coexistence proxy is small, its required bandwidth is not high, and thus the probability of crash by attack is reduced. In addition, the RTK mechanism adopted by the present invention further restricts the bandwidth of the illegal signaling.

Though illustration and description of the present disclosure have been given with reference to exemplary embodiments thereof, it should be appreciated by persons of ordinary skill in the art that various changes in forms and details can be made without deviation from the spirit and scope of this disclosure, which are defined by the appended claims.

What is claimed is:

1. A proxy server, having proxy server address information, comprising:
a proxy database, adapted to store base station address information of at least one base station and base station identification information corresponding to the base station address information; and
a processing unit, adapted to replace the base station source address information in a first message from the at least one source base station with the proxy server address information of the proxy server, and send a second message carrying the proxy server address information to a target address.

2. The proxy server according to claim 1, further comprising:
a base station side logic interface, adapted to receive the first message from the at least one base station, and send a third message to the at least one base station; and
a network side logic interface, adapted to send the second message to the target address, and receive the second message from the source address.

3. The proxy server according to claim 1, wherein the at least one base station is a license-exempt band base station.

4. The proxy server according to claim 1, wherein the proxy server comprises a coexistence proxy server; and
the proxy server is integrated with the base station in an entity.

5. A method for realizing proxy by the proxy server of claim 1, comprising:
A. pre-storing base station address information of at least one base station and base station identification information corresponding to the base station address information;
B. replacing base station source address information in a first message from the at least one base station with proxy server address information of the proxy server; and
C. sending a second message carrying the proxy server address information to a target address.

6. The method according to claim 5, wherein the Step B further comprises:
parsing the first message from the at least one base station, and adopting a processing unit to add the base station identification information corresponding to the base station address information of the at least one base station into the first message when no base station identification information exists in the first message from the at least one base station, so as to generate the second message carrying the base station identification information and the proxy server address information.

7. The method according to claim 5, wherein the Step A further comprises: pre-storing a mapping relationship table to establish a corresponding relationship between the base station address information of the at least one base station and the base station identification information;
the Step B further comprises: receiving, by the processing unit, the second message from any source address, looking up the base station address information in the mapping relationship table according to the base station identification information, altering the target address of the second message into the base station address information according to the base station address information, and then sending the base station address information to a third message.

8. The method according to claim 7, further comprising:
receiving the first message from the at least one base station, and sending the third message to the at least one base station; and
sending the second message to the target address, and receiving the second message from the source address.

9. The method according to claim 5, wherein the Step A further comprises:
storing an illegal proxy server address list in the database, and shielding, by the processing unit, information from illegal proxy servers according to the illegal proxy server address list.

10. The method according to claim 5, wherein the base station identification comprises, but not limited to, a globally unique base station identification or an unique identification in the proxy server for the BS according to internal rules of the proxy server.

11. A secure communication system, comprising:
at least one base station, and the proxy server of claim 1 adapted to serve as an agent for the at least one base station to perform secure communication.

12. The secure communication system according to claim 11, wherein each base station is connected to a proxy server; or multiple base stations share one proxy server; or
one base station is connected to one multiple proxy servers.

13. A secure communication method, for achieving secure communication at least between a first base station and a second base station, wherein the first base station comprises at least one first proxy server, the method comprising:
I. sending, by the first base station, a first message to the second base station, wherein the first message comprises a first network address of the first proxy server and a first base identification of the first base station; and
II. sending, by the second base station, a contact request message to the first base station according to the first base station identification carried in the first message, and sending, by the first base station, a response message to the second base station to achieve secure communication with the second base station.

14. The method according to claim 13, wherein the Step II yet comprises:
II1. sending, by the second base station, a request message to the first proxy server according to the received first network address, and forwarding, by the first proxy server, the request message from the second base station to the first base station; and
II2. sending, by the first base station, a response message to the first proxy server, and forwarding, by the first proxy server, the response message from the first base station to the second base station.

15. The method according to claim 13, wherein the first base station wirelessly broadcasts the first message, and receives the contact request message through wired connection; and in the Step II, before sending the contact response message, the method further comprises:
determining, by the first base station, whether the contact request message directly comes from the second BS, and if the contact request message directly comes from the second BS, proceeding to Step II; if the contact request message does not directly come from the second BS, performing the following steps;
T1. determining whether the contact request message comes from the first proxy server, and if the contact request message comes from the first proxy server, performing Step T2; if the contact request message does not come from the first proxy server, performing Step T3;
T2. sending, by the first BS, a feedback message to the second BS through the first proxy server so as to establish a secure connection with the second BS, and ending the process; and
T3. determining, by the first BS, the contact request message as an illegal contact request, then discarding the message, and ending the process.

16. The method according to claim 13, further comprising:
S1. receiving, by the second base station, a report message from the first base station, and obtaining from the report message the network address of the proxy server and the base station identification of the first base station;
S2. determining, by the second base station, whether the first base station is a base station sharing mutual trust with the second base station, and if the first base station is a base station sharing mutual trust with the second base station, performing Step S3; if the first base station is not a base station sharing mutual trust with the second base station, performing Step S4;
S3. directly sending, by the second base station, the contact request message to the network address of the first base station or the first proxy server; receiving, by the second base station, the feedback message from the first base station or the first proxy server so as to directly contact the first base station and ending the process; and
S4. sending, by the second base station, the contact request message to the first proxy server of the first base station through a second proxy server of the second base station; and receiving, by the second base station, the feedback message from the first base station through the second proxy server so as to contact the first base station.

17. The method according to claim 13, wherein the first message further comprises a real-time key.
